(19) United States
(12) Patent Application Publication
(10) Pub. No.: US 2026/0010358 A1
(43) Pub. Date: Jan. 8, 2026

(54) SYSTEM, METHOD, AND COMPUTER PROGRAM FOR MANAGING VEHICLE SOFTWARE UPDATES

(71) Applicant: TOYOTA JIDOSHA KABUSHIKI KAISHA, Toyota-shi (JP)

(72) Inventors: Caleb MCGARY, Tokyo (JP); Jean-François BASTIEN, Tokyo (JP); Marc CARRE, Tokyo (JP); Peter BERGER, Tokyo (JP)

(73) Assignee: TOYOTA JIDOSHA KABUSHIKI KAISHA, Toyota-shi (JP)

(21) Appl. No.: 18/763,031

(22) Filed: Jul. 3, 2024

(51) Int. Cl. G06F 8/65; G06F 8/71

(52) U.S. Cl. CPC G06F 8/65; G06F 8/71

(57) ABSTRACT

Provided are system, method, and device for automatically managing vehicle software updates. According to example embodiments, the system may include: a memory storage storing computer-executable instructions; and at least one processor communicatively coupled to the memory storage, wherein the at least one processor may be configured to execute the instructions to: receive software information from a nearby vehicle, wherein the software information may include a version of a software of the nearby vehicle; generate a software update based on a hashmap indicating one or more differences between a current version of the software and the version of the software of the nearby vehicle, wherein the software update may be formed from a plurality of data chunks; and transmit the software update to the nearby vehicle by individually transmitting the plurality of data chunks to the nearby vehicle.

### TECHNICAL FIELD

Systems, methods, and computer programs consistent with example embodiments of the present disclosure relate to a software update, and more specifically, relate to the management of software updates for a vehicle.

### BACKGROUND

Modern vehicles are capable of performing a wide range of complex functions, such as generating telemetry data, transmitting and receiving data via the internet, and the like. In order for the vehicles to perform the above functions, said vehicles are inherently connected to an upstream server. In this regard, in order to maintain the most up to date information and reliably perform the above functions when connecting to the server, software updates are regularly transmitted to the vehicle to perform updates to the vehicle.

In the related art, in order for a vehicle to receive a software update, such software update may be transmitted from the server to the vehicle over-the-air (OTA) either as a single entire software update or as a sequential software updates. Nevertheless, the above approach for managing the software update may have at least the following shortcomings.

Since the software update is transmitted either as a single entire software update or as a sequential software updates, if the vehicle is unable to complete the update process for any reason (e.g., disconnected from the server, and the like), the update process may need to be restarted from the beginning where the software update has to be transmitted again. Further, if the vehicle has skipped one or more versions of the software update, the update process may still need to be performed with all of the skipped versions of the software updates regardless of the similarities between the skipped versions of the software updates. As a result, the amount of time for performing the update process may be increased.

### SUMMARY

Example embodiments of the present disclosure automatically manage vehicle software updates. As such, example embodiments of the present disclosure allows for software update to be transmitted and applied to a vehicle in a tailored manner while avoiding the case where update process has to be restarted from the beginning.

According to example embodiments, a system is provided. The system may include: a memory storage storing computer-executable instructions; and at least one processor communicatively coupled to the memory storage, wherein the at least one processor may be configured to execute the instructions to: receive software information from a nearby vehicle, wherein the software information may include a version of a software of the nearby vehicle; generate a software update based on a hashmap indicating one or more differences between a current version of the software and the version of the software of the nearby vehicle, wherein the software update may be formed from a plurality of data chunks; and transmit the software update to the nearby vehicle by individually transmitting the plurality of data chunks to the nearby vehicle.

According to example embodiments, the at least one processor may be configured to execute the instructions to generate the software update by: determining the one or more differences between the current version of the software and the version of the software of the nearby vehicle; generating the hashmap based on the one or more differences; obtaining data associated with the one or more differences based on the hashmap; and dividing the data into the plurality of data chunks to form the software update.

According to example embodiments, the at least one processor may be configured to execute the instructions to transmit the software update by: determining priorities of the plurality of data chunks; and individually transmitting the plurality of data chunks to the nearby vehicle based on the priorities.

According to example embodiments, the priorities of the plurality of data chunks may be determined based on one or more of an update applicability of the respective one of the plurality of data chunks, a size of the respective one of the plurality of data chunks, a safety impact of the respective one of the plurality of data chunks, and a reboot of ECU applicability of the respective one of the plurality of data chunks.

According to example embodiments, the one or more differences between the current version of the software and the version of the software of the nearby vehicle may be determined based on a differential comparison algorithm.

According to example embodiments, the differential comparison algorithm may include Levenshtein distance algorithm.

According to example embodiments, the plurality of data chunks may be individually transmitted via torrent.

According to example embodiments, the software of the nearby vehicle may be divided into at least an application partition and a base partition, and wherein the nearby vehicle may be configured to update the software of the nearby vehicle by applying the plurality of data chunks of the software update to a corresponding portions of the application partition and a corresponding portions of the base partition.

According to example embodiments, a method is provided. The method may include: receiving software information from a nearby vehicle, wherein the software information may include a version of a software of the nearby vehicle; generating a software update based on a hashmap indicating one or more differences between a current version of the software and the version of the software of the nearby vehicle, wherein the software update may be formed from a plurality of data chunks; and transmitting the software update to the nearby vehicle by individually transmitting the plurality of data chunks to the nearby vehicle.

According to example embodiments, the generating the software update may include: determining the one or more differences between the current version of the software and the version of the software of the nearby vehicle; generating the hashmap based on the one or more differences; obtaining data associated with the one or more differences based on the hashmap; and dividing the data into the plurality of data chunks to form the software update.

According to example embodiments, the transmitting the software update may include: determining priorities of the plurality of data chunks; and individually transmitting the plurality of data chunks to the nearby vehicle based on the priorities.

According to example embodiments, the priorities of the plurality of data chunks may be determined based on one or more of an update applicability of the respective one of the plurality of data chunks, a size of the respective one of the plurality of data chunks, a safety impact of the respective one of the plurality of data chunks, and a reboot of ECU applicability of the respective one of the plurality of data chunks.

According to example embodiments, the one or more differences between the current version of the software and the version of the software of the nearby vehicle may be determined based on a differential comparison algorithm.

According to example embodiments, the differential comparison algorithm may include Levenshtein distance algorithm.

According to example embodiments, the plurality of data chunks may be individually transmitted via torrent.

According to example embodiments, the software of the nearby vehicle may be divided into at least an application partition and a base partition, and wherein the nearby vehicle may be configured to update the software of the nearby vehicle by applying the plurality of data chunks of the software update to a corresponding portions of the application partition and a corresponding portions of the base partition.

According to example embodiments, a non-transitory computer-readable recording medium is provided. The non-transitory computer-readable recording medium may have recorded thereon instructions executable by at least one processor to cause the at least one processor to perform a method including: receiving software information from a nearby vehicle, wherein the software information may include a version of a software of the nearby vehicle; generating a software update based on a hashmap indicating one or more differences between a current version of the software and the version of the software of the nearby vehicle, wherein the software update may be formed from a plurality of data chunks; and transmitting the software update to the nearby vehicle by individually transmitting the plurality of data chunks to the nearby vehicle.

According to example embodiments, the generating the software update may include: determining the one or more differences between the current version of the software and the version of the software of the nearby vehicle; generating the hashmap based on the one or more differences; obtaining data associated with the one or more differences based on the hashmap; and dividing the data into the plurality of data chunks to form the software update.

According to example embodiments, the transmitting the software update may include: determining priorities of the plurality of data chunks; and individually transmitting the plurality of data chunks to the nearby vehicle based on the priorities.

According to example embodiments, the one or more differences between the current version of the software and the version of the software of the nearby vehicle may be determined based on a differential comparison algorithm.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a block diagram of an example system configuration for managing vehicle software updates, according to one or more embodiments;

FIG. 2 illustrates a block diagram of example components in a Software Update Management (SUM) system, according to one or more embodiments;

FIG. 3 illustrates a flow diagram of an example method for managing vehicle software updates, according to one or more embodiments; and

FIG. 4 illustrates a flow diagram of an example method 400 for generating and transmitting a software update, according to one or more embodiments.

### DETAILED DESCRIPTION

The following detailed description of example embodiments refers to the accompanying drawings. The same reference numbers in different drawings may identify the same or similar elements.

The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]” are to be understood as including only A, only B, or both A and B.

It is contemplated that features, advantages, and significances of example embodiments described hereinabove are merely a portion of the present disclosure, and are not intended to be exhaustive or to limit the scope of the present disclosure.

Further descriptions of the features, components, configuration, operations, and implementations of the threshold tuning system of the present disclosure, according to one or more embodiments, are provided in the following.

### Example System Architecture

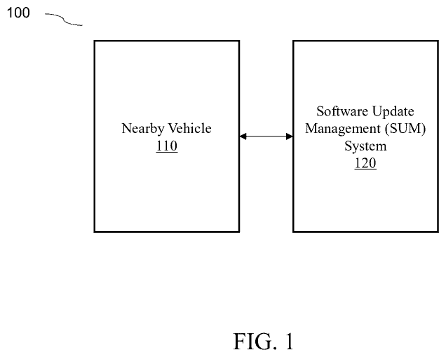

FIG. 1 illustrates a block diagram of an example system configuration 100 for managing vehicle software updates, according to one or more embodiments. As illustrated in FIG. 1, system configuration 100 may include a nearby vehicle 110 and a Software Update Management (SUM) system 120.

The SUM system 120 may include an apparatus, a system, a platform, a module, or the like, which may be configured to perform one or more operations or actions for managing vehicle software updates. According to example embodiments, the SUM system 120 may be installed in any kind of object, unit, or device that includes a software that is the same as the software installed in the nearby vehicle 110. For example, the SUM system 120 may be installed in a vehicle (hereinafter “current vehicle”) that includes a software that is the same as the software installed in the nearby vehicle 110. In another example, the SUM system 120 may be installed in a beacon that includes a software that is the same as the software installed in the nearby vehicle 110. According to example embodiments, the SUM system 120 may be installed in a plurality of objects, units, and/or devices, where such plurality of objects, units, and/or devices may be communicatively coupled to each other. For example, the SUM system 120 may be included in a plurality of vehicles, and may be configured to communicate with each other.

Further, according to example embodiments, the SUM system 120 may include one or more components that enable the SUM system 120 to communicate with the nearby vehicle 110. For example, the SUM system 120 may include a Digital Communications Module (DCM). The DCM may be an electronic control unit (ECU) that contains a cellular modem, and may be configured to communicate with the nearby vehicle 110 via shortwave radio, direct communication between DCM and DCM, Bluetooth, and the like. According to example embodiments, all transmissions between the SUM system 120 and the nearby vehicle 110 may be encrypted.

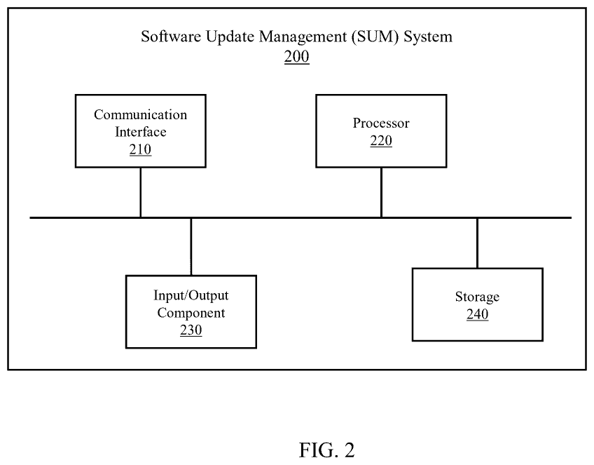

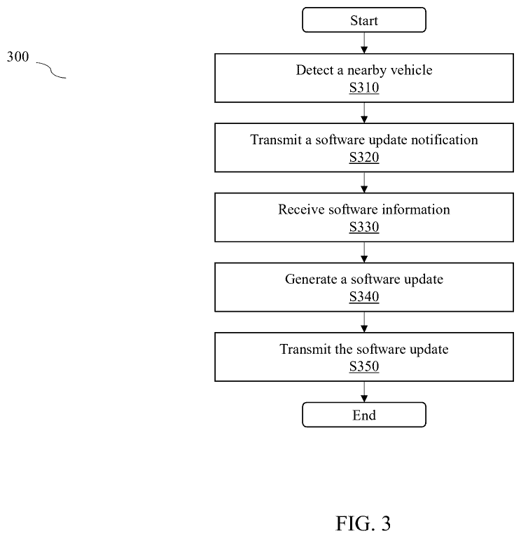

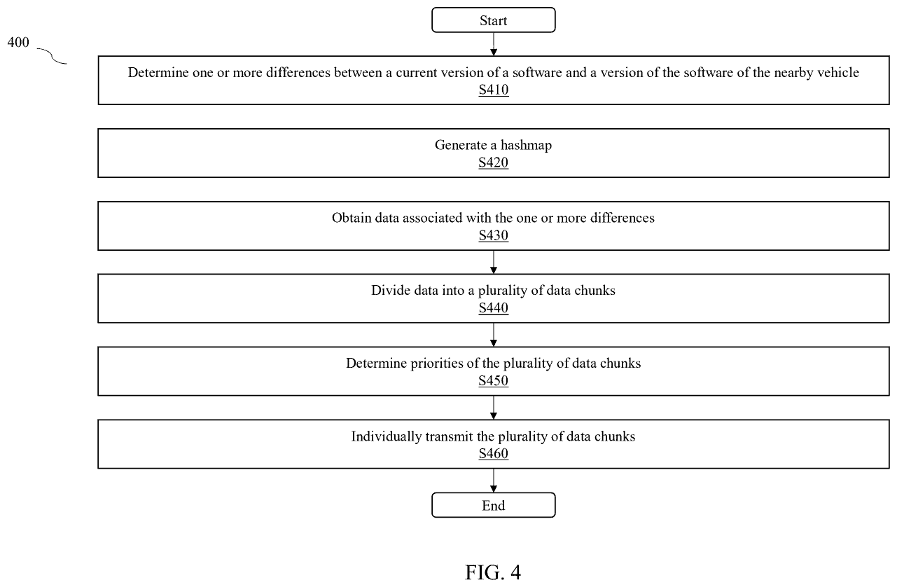

Example operations performable by the SUM system 120 for managing vehicle software updates are described below with reference to FIG. 3 to FIG. 4. Further, several example components which may be included in the SUM system 120, according to one or more embodiments, are described below with reference to FIG. 2.

The nearby vehicle 110 may include any kind of vehicle that is traveling near the SUM system 120 and that includes a software that is the same as the software installed in the SUM system 120. For example, nearby vehicle 110 may include a vehicle that is traveling in the same direction and within a communication range of the SUM system 120 installed in the current vehicle, where both vehicles have the same software installed.

According to example embodiments, the software installed in the nearby vehicle 110 may be of a different version than the software installed in the SUM system 120. For example, the current vehicle and the SUM system 120 may have received the latest update of the software from a server, but the nearby vehicle 110 may not yet receive the latest update of the software. Accordingly, the version of the software installed in the SUM system 120 may be the latest version, while the version of the software installed in the nearby vehicle 110 may be an older version. According to example embodiments, the software installed in the nearby vehicle 110 may be of the same version as the software installed in the SUM system 120.

According to example embodiments, the nearby vehicle 110 may also include the SUM system 120. According to example embodiments, nearby vehicle 110 may not include the SUM system 120, but may still be able to communicate with the SUM system 120.

FIG. 2 illustrates a block diagram of example components in a SUM system 200, according to one or more embodiments. The SUM system 200 may correspond to the SUM system 120 in FIG. 1, thus the features associated with the SUM system 120 and the SUM system 200 may be similarly applicable to each other, unless being explicitly described otherwise.

As illustrated in FIG. 2, the SUM system 200 may include at least one communication interface 210, at least one processor 220, at least one input/output component 230, and at least one storage 240, although it can be understood that the SUM system 200 may include more or less components than as illustrated in FIG. 2, and/or may be arranged in a manner different from as illustrated in FIG. 2, without departing from the scope of the present disclosure.

The communication interface 210 may include at least one transceiver-like component (e.g., a transceiver, a separate receiver and transmitter, a bus, etc.) that enables the components of the SUM system 200 to communicate with each other and/or to communicate with one or more components external to the SUM system 200, such as via a wired connection, a wireless connection, or a combination of wired and wireless connections. For example, the communication interface 210 may include an Ethernet interface, an optical interface, a coaxial interface, an infrared interface, a radio frequency (RF) interface, a universal serial bus (USB) interface, a Wi-Fi interface, a cellular network interface, or the like.

For instance, the communication interface 210 may couple the processor 220 to the storage 240 to thereby enable them to communicate and to interoperate with each other in performing one or more operations. As another example, communication interface 210 may couple the SUM system 200 (or one or more components included therein) to the nearby vehicle 110, so as to enable them to communicate and to interoperate with each other.

According to one or more embodiments, the communication interface 210 may include one or more application programming interfaces (APIs) which allow the SUM system 200 (or one or more components included therein) to communicate with one or more software applications (e.g., software application deployed in the nearby vehicle 110, etc.).

The input/output component 230 may include at least one component that permits the SUM system 200 to receive information and/or to provide output information. It can be understood that, in some embodiments, the input/output component 230 may include at least one input component (e.g., a touch screen display, a keyboard, a keypad, a mouse, a button, a switch, a microphone, etc.) and at least one output component (e.g., a display, a speaker, one or more light-emitting diodes (LEDs), etc.), each of which may be separated from each other. Additionally, or alternatively, the at least one input component may include a sensor for sensing information (e.g., a global positioning system (GPS) component, an accelerometer, a gyroscope, and/or an actuator).

The storage 240 may include one or more storage mediums suitable for storing data, information, and/or computer-executable instructions therein. According to example embodiments, the storage 240 may include at least one memory storage, such as a random access memory (RAM), a read only memory (ROM), and/or another type of dynamic or static storage device (e.g., a flash memory, a magnetic memory, and/or an optical memory) that stores information and/or instructions for use by the processor 220. Additionally or alternatively, the storage 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. A computer-readable medium is defined herein as a non-transitory memory device. A memory device includes memory space within a single physical storage device or memory space spread across multiple physical storage devices.

According to example embodiments, the storage 240 may be configured to store information, such as raw data, metadata, or the like. Additionally or alternatively, the storage 240 may be configured to store one or more information associated with one or more operations performed by the processor 220. For instance, the storage 240 may store information defining the historical operation(s) performed by the processor 220 to manage vehicle software updates, one or more results of operations performed by the processor 220, or the like. Further, the storage 240 may store data or information required in managing vehicle software updates.

In some implementation, the storage 240 may include a plurality of storage mediums, and the storage 240 may be configured to store a duplicate or a copy of at least a portion of the information in the plurality of storage mediums, for providing redundancy and for backing-up the information or the associated data. Furthermore, the storage 240 may also store computer-readable or computer-executable instructions which, when being executed by one or more processors (e.g., processor 220), causes the one or more processors to perform one or more actions/operations described herein

The processor 220 may include at least one processor capable of being programmed or being configured to perform a function(s) or an operation(s) described herein. For instance, the processor 220 may be configured to execute computer-executable instructions stored in at least one storage medium or a memory storage (e.g., storage 240, etc.) to thereby perform one or more actions or one or more operations described herein.

According to example embodiments, the processor 220 may be configured to receive (e.g., via the communication interface 210, via the input/output component 230, etc.) one or more signals and/or one or more user inputs defining one or more instructions for performing one or more operations. Further, the processor 220 may be implemented in hardware, firmware, or a combination of hardware and software. For instance, processor 220 may include at least one of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing or computing component.

According to example embodiments, the processor 220 may be configured to collect, to extract, and/or to receive one or more information (in the form of signal or data, etc.) from the nearby vehicle 110, and to process the received one or more information to thereby manage vehicle software updates.

The number and arrangement of components shown in FIG. 2 are provided as an example. In practice, SUM system 200 may include additional components, fewer components, different components, or differently arranged components than those shown in FIG. 2. Additionally, or alternatively, a set of components (e.g., one or more components) of SUM system 200 may perform one or more functions described as being performed by another set of components of SUM system 200.

Descriptions of several example operations which may be performed by the processor 220 are provided below with reference to FIG. 3 to FIG. 4.

### Example Operations for Managing Vehicle Software Updates in the Present Disclosure

In the following, several example operations performable by the SUM system of the present disclosure are described with reference to FIG. 3 to FIG. 4.

FIG. 3 illustrates a flow diagram of an example method 300 for managing vehicle software updates, according to one or more embodiments. One or more operations in method 300 may be performed by at least one processor (e.g., processor 220) of the SUM system.

As illustrated in FIG. 3, at operation S310, the at least one processor may be configured to detect a nearby vehicle. The nearby vehicle may include any kind of vehicle that is traveling near the SUM system and that includes a software that is the same as the software installed in the SUM system.

According to example embodiments, the at least one processor may be configured to detect the nearby vehicle by broadcasting a discovery transmission. The discovery transmission may be discovered and received by vehicles that are traveling within the communication range of the SUM system. In this regard, if the nearby vehicle receives the discovery transmission, the nearby vehicle may be configured to transmit a discovery transmission back to the SUM system. Accordingly, the at least one processor may be configured to detect the nearby vehicle by further receiving the discovery transmission from the nearby vehicle.

According to example embodiments, once the nearby vehicle is detected, the at least one processor may be configured to perform authentication with the nearby vehicle. The authentication may be performed in order to confirm that the SUM system and the nearby vehicle are trustworthy to each other. According to example embodiments, the authentication may be performed via public key cryptography (e.g., signature for authentication). The method then proceeds to operation S320.

At operation S320, the at least one processor may be configured to transmit a software update notification. The software update notification may be transmitted to the nearby vehicle, and may include information regarding the software of the SUM system (i.e., the software installed in a current vehicle where the SUM system is installed), which is available for updating the software of the nearby vehicle. According to example embodiments, the software update notification may include a version of the software of the SUM system. According to example embodiments, the software update notification may further include a message indicating that the SUM system has a software update that can be provided.

According to example embodiments, once the nearby vehicle receives the software update notification, the nearby vehicle may be configured to determine whether an update is necessary for the software of the nearby vehicle based on the software update notification. According to example embodiments, the nearby vehicle may be configured to determine whether the update is necessary by determining whether a version of the software of the nearby vehicle is older than the version of the software of the SUM system indicated in the software update notification.

Accordingly, based on determining that the version of the software of the nearby vehicle is older than the version of the software of the SUM system, the nearby vehicle may determine that the update is necessary, and then transmit a software information to the SUM system. The software information may include information regarding the software of the nearby vehicle, such as the version of the software of the nearby vehicle.

On the other hand, based on determining that the version of the software of the nearby vehicle is not older than the version of the software of the SUM system (e.g., same version), the nearby vehicle may determine that the update is not necessary. In this regard, the nearby vehicle may transmit a notification to the SUM system indicating that the version of the software of the nearby vehicle is the same as the version of the software of the SUM system and that the update is not necessary. Alternatively, the nearby vehicle may simply ignore the software update notification without transmitting any notification back to the SUM system.

According to example embodiments, the at least one processor may be configured to transmit the software update notification in response to detecting the nearby vehicle. According to example embodiments, the at least one processor may be configured to transmit the software update notification in response to receiving an update request from the nearby vehicle. In particular, once the nearby vehicle and the SUM system detect each other, the nearby vehicle may determine whether to transmit the update request. The update request may comprise a request to receive software update information. According to example embodiments, the nearby vehicle may determine whether or not to transmit the update request based on one or more trigger conditions. The one or more trigger conditions may include, for example, one or more of an amount of time since the nearby vehicle last received an update, daylight saving, geographical location, gas fill status, and the like. Accordingly, in response to determining to transmit the update request, the nearby vehicle may be configured to transmit the update request to the SUM system. According to example embodiments, the at least one processor may be configured to transmit the software update notification in response to detecting the nearby vehicle even if no update request is received from the nearby vehicle. The method then proceeds to operation S330.

At operation S330, the at least one processor may be configured to receive the software information. As described above, the software information may be received from the nearby vehicle in response to the nearby vehicle determining that the update is necessary, and may include information regarding the software of the nearby vehicle, such as the version of the software of the nearby vehicle. The method then proceeds to operation S340.

At operation S340, the at least one processor may be configured to generate a software update. According to example embodiments, the software update may be generated based on a hashmap indicating one or more differences between the version of the software of the SUM system (i.e., a current version of the software) and the version of the software of the nearby vehicle indicated in the software information. Further, according to example embodiments, the software update may include only update data associated with the one or more differences, and may be formed from a plurality of data chunks. The method then proceeds to operation S350.

At operation S350, the at least one processor may be configured to transmit the software update. The software update may be transmitted to the nearby vehicle for performing update to the software of the nearby vehicle. According to example embodiments, the software update may be transmitted by individually transmitting the plurality of data chunks (which form the software update) to the nearby vehicle.

Additional descriptions and examples of operations for generating and transmitting a software update are described below with reference to FIG. 4.

Once the software update is transmitted to the nearby vehicle, the nearby vehicle may be configured to apply the software update to update the software of the nearby vehicle.

Upon performing operation S350, the method 300 may be ended or be terminated. Alternatively, method 300 may return to operation S310, such that the at least one processor may be configured to repeatedly perform, for at least a predetermined amount of time, the detecting the nearby vehicle (at operation S310), the transmitting the software update notification (at operation S320), the receiving the software information (at operation S330), the generating the software update (at operation S340), and the transmitting the software update (at operation S350). For instance, the at least one processor may continuously (or periodically) detect more nearby vehicles, and then restart the detecting the nearby vehicle (at operation S310), the transmitting the software update notification (at operation S320), the receiving the software information (at operation S330), the generating the software update (at operation S340), and the transmitting the software update (at operation S350).

### Example Operations for Generating and Transmitting a Software Update in the Present Disclosure

FIG. 4 illustrates a flow diagram of an example method 400 for generating and transmitting a software update, according to one or more embodiments. One or more operations of method 400 may be part of operation S340 and S350 in method 300, and may be performed by at least one processor (e.g., processor 220) of the SUM system.

As illustrated in FIG. 4, at operation S410, the at least one processor may be configured to determine one or more differences between a current version of a software (i.e., the version of the software of the SUM system) and a version of the software of the nearby vehicle.

According to example embodiments, the one or more differences may be any form of differences between the current version of the software and the version of the software of the nearby vehicle. Here, it may be assumed that the version of the software of the nearby vehicle is older than the current version of the software, and may have at least one difference. According to example embodiments, the one or more differences may indicate one or more differences between one or more sections of a code representing the current version of the software and one or more sections of a code representing the version of the software of the nearby vehicle

Further, the one or more differences may indicate one or more sections of a code representing the version of the software of the nearby vehicle which are different from a code representing the current version of the software, such that the one or more sections of the code representing the version of the software of the nearby vehicle would require some additions, deletions, and/or modifications in order to transform the code representing the version of the software of the nearby vehicle into the code representing the current version of the software.

According to example embodiments, the one or more differences between the current version of the software and the version of the software of the nearby vehicle may be determined based on a differential comparison algorithm. The differential comparison algorithm may include, for example, a Levenshtein distance algorithm, and the like. The method then proceeds to operation S420.

At operation S420, the at least one processor may be configured to generate a hashmap. The hashmap may be generated based on the one or more differences, and may include a mapping of one or more sections of the code representing the current version of the software to a corresponding one or more sections of the code representing the version of the software of the nearby vehicle that is different.

For example, if a section associated with an interface function of the software in the code representing the version of the software of the nearby vehicle is different from a section associated with the interface function of the software in the code representing the current version of the software, the hashmap may include a mapping between the above sections. The method then proceeds to operation S430.

At operation S430, the at least one processor may be configured to obtain data associated with the one or more differences based on the hashmap. The data may be obtained from the current version of the software. For example, the at least one processor may be configured to obtain data associated with the interface function of the software from the code representing the current version of the software based on the hashmap.

Here an example is provided. In between the version of the software of the nearby vehicle and the current version of the software, a software developer may have modified the code/data for the interface function of the software. Accordingly, at operation S410, a section associated with the interface function of the software in the code representing the version of the software of the nearby vehicle may be determined to be different from a section associated with the interface function of the software in the code representing the current version of the software; where such section associated with the interface function of the software in the code representing the version of the software of the nearby vehicle would require modifications in order to transform the code representing the version of the software of the nearby vehicle into the code representing the current version of the software. Then, at operation S420, the hashmap may be generated, which maps the above sections together. Subsequently, at operation S430, the data associated with the interface function of the software may be obtained from the current version of the software based on the hashmap, such that said data may be transmitted to the nearby vehicle (see below) to modify the section associated with the interface function of the software in the code representing the version of the software of the nearby vehicle in order to transform the code representing the version of the software of the nearby vehicle into the code representing the current version of the software.

Accordingly, the software update that is tailored for the nearby vehicle may be generated, where the software update may include only update data associated with the one or more differences. As such, even if the nearby vehicle has skipped one or more versions of the software update, the update process does not need to be performed with all of the skipped versions of the software updates, and the update process may be performed in relation to only the one or more differences. The method then proceeds to operation S440.

At operation S440, the at least one processor may be configured to divide the data into a plurality of data chunks to form the software update. The data may be divided into the plurality of data chunks in the manner as known in the related art. The method then proceeds to operation S450.

At operation S450, the at least one processor may be configured to determine priorities of the plurality of data chunks. The priorities may be determined based on one or more of an update applicability of the respective one of the plurality of data chunks, a size of the respective one of the plurality of data chunks, a safety impact of the respective one of the plurality of data chunks, and a reboot of ECU applicability of the respective one of the plurality of data chunks, and the like. For example, if the data is divided into 3 data chunks, where one data chunk may be applied to provide an update to a section associated with the interface function by itself, while the remaining two data chunks must be applied together to provide an update to a section associated with an infotainment function, the one data chunk (to be applied to provide an update to the section associated with the interface function) may be determined to have the highest priority followed by the remaining two data chunks (to be applied to provide an update to the section associated with the infotainment function). The method then proceeds to operation S460.

At operation S460, the at least one processor may be configured to individually transmit the plurality of data chunks to the nearby vehicle based on the priorities. It may be understood that individually transmitting the plurality of data chunks based on the priorities may include transmitting each of the plurality of data chunks one by one based on the priorities. For example, the data chunk with the highest priority may be transmitted first, followed by the data chunk with the second highest priority, and the like. According to example embodiments, the plurality of data chunks may be individually transmitted via torrent.

Accordingly, since the software update may be transmitted to the nearby vehicle in the form of data chunks where the data chunks are applied for the update process individually (see below), if the nearby vehicle is unable to complete the update process for any reason, the update process may not need to be restarted from the beginning and may simply need to be restarted from the data chunk which was being applied/transmitted when the update process was interrupted.

In view of the above, since the software update only includes update data associated with the one or more differences and the update process only needs to be restarted from the data chunk that was being applied/transmitted when the update process was interrupted, the amount of data that needs to be transmitted for the update process may be minimized. Further, for the similar reason, the lifespan of a memory disk may be maximized by not having to read/write unnecessary data for the update process, and the overall usage of computational resources for the update process may be reduced.

Once the software update is transmitted to the nearby vehicle, the nearby vehicle may be configured to apply the software update to update the software of the nearby vehicle.

According to example embodiments, the software may be divided into at least an application partition and a base partition. The application partition and the base partition may be physical partitions or logical partitions. For example, the application partition and the base partition may be logical partitions that are enforced by a configuration of an operating system itself, which enables software that does not conform to or is aware of the partitioning mechanism to still perform an update.

The base partition may comprise non-malleable data and/or data that is less likely to change or evolve over time. According to example embodiments, the base partition may comprise data related to math libraries, localization support, help files, common operating system components, safety calibration data that is hard tied to the vehicle hardware, data related to safety critical elements, and the like. In other words, the base partition may comprise all data that will not require updating or is less likely to require an update on a regular basis. According to example embodiments, the data of the base partition may be in a central location within the vehicle hardware, and may operate in a secure boot.

The application partition may comprise malleable data and/or data that is more likely to change or evolve over time. According to example embodiments, the application partition may comprise data related to infotainment applications, non-safety related functions, and the like. According to example embodiments, the application partition may comprise a plurality of sub-partitions, where each of the plurality of sub-partitions may comprise data related to one or more of the applications and functions of the application partition. According to example embodiments, the application partition may operate in a distributed fashion in various parts of the nearby vehicle.

According to example embodiments, the application partition and the base partition may be divided based on an update record. The update record may include information regarding past update processes of vehicles with similar models as the model of the nearby vehicle, and may indicate a frequency of change for all data of the software during the past update processes.

In particular, an image of the software may be generated after every update process, where the images of the software after the past update processes may be compared with each other to determine which data of the software is frequently changed throughout the past update processes and which data of the software is not so frequently changed (or has never been changed) throughout the past update processes. The files associated with the images may be hashed and have their timestamp recorded. Accordingly, the data of the software that is frequently changed throughout the past update processes may be determined as the application partition, while the data of the software that is not so frequently changed (or has never been changed) throughout the past update processes may be determined as the base partition.

According to example embodiments, the application partition and the base partition may be divided based on a safety criticality. The safety criticality may indicate which data of the software is safety critical and which data of the software is not safety critical. Accordingly, data of the software that is safety critical may be determined as the base partition, while the data of the software that is not safety critical may be determined as the application partition.

According to example embodiments, the application partition and the base partition may be divided based on a combination of an update record and a safety criticality.

According to example embodiments, data associated with the user (e.g., driver) may always be determined to be frequently changed, such that the data associated with the user is always part of the application partition. According to example embodiments, the data associated with the user may be determined to be within a user partition separate from the application partition and the base partition. The user partition may be a logical partition, or may be a logical and physical partition (i.e., be both logically and physically separated from the application partition and the base partition), in order to enable ease of erasure and to satisfy privacy related requirements. According to example embodiments, the data associated with the user within the user partition may comprise user profile data, application logs, data collected by the vehicle itself (e.g. sensor data around the time of an ADAS disengagement collected for further analysis and continuous improvement), and the like.

According to example embodiments, the data within the base partition and the data within the application partition may coordinate with each other. For example, data within the application partition may pull capabilities from the data within the base partition. In such case, having the base partition and the application partition be logical partitions may prevent potential interoperability issues. Further, according to example embodiments, dependencies between the base partition and the application partition may be expressed in metadata in a continuous integration and continuous delivery/deployment (CI/CD) system, tested, and enforced at installation and boot time. The dependencies may be part of a Software Bill of Materials (SBOM) which is a unique structured list of software and materials for each vehicle.

According to example embodiments, the software may further be divided into a companion data partition. The companion data partition may be a physical partition or a logical partition. The companion data partition may be associated with the application partition and the base partition, and may comprise data related to configuration, data related to calibration, other vehicle non-user related data, and the like. The data within the companion data partition may be read by the code in the associated partitions, where the code must be engineered in such a way that the data can be updated without adding safety risks.

In view of the above, the nearby vehicle may be configured to update the software of the nearby vehicle by applying the plurality of data chunks of the software update to a corresponding portions of the application partition and a corresponding portions of the base partition.

In particular, the plurality of data chunks may be applied to one or both data in the application partition and data in the base partition. For example, one or more of the plurality of data chunks may correspond to data related to interface functions (i.e., non safety related), and thus, said one or more of the plurality of data chunks may be applied to data within a partition related to interface functions within the application partition.

According to example embodiments, the plurality of data chunks of the software update may be applied to the corresponding portions of the application partition based on user impact and/or computational requirements. For example, if the plurality of data chunks correspond to data related to functions which the user is not currently using, the plurality of data chunks of the software update may be applied immediately. On the other hand, if the plurality of data chunks correspond to data related to functions which the user is currently using, the plurality of data chunks of the software update may be applied at a later time when the user is not using such functions.

According to example embodiments, the plurality of data chunks of the software update may be applied to the corresponding portions of the base partition based on user safety.

Accordingly, the partitioning of software between the base partition and the application partition as well as the division of the software update into the plurality of data chunks allow for updates to be applied individually to each of the partitions as well as within the application partition, rather than being applied to the software as a whole at once.

According to example embodiments, the software update may further include a cryptographic signature, where the cryptographic signature may be used by the nearby vehicle for authentication and safeguard against tampering when receiving the software update.

### Various Aspects of Embodiments

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s) module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A system comprising:
a memory storage storing computer-executable instructions; and
at least one processor communicatively coupled to the memory storage, wherein the at least one processor is configured to execute the instructions to:
receive software information from a nearby vehicle, wherein the software information comprises a version of a software of the nearby vehicle;
generate a software update based on a hashmap indicating one or more differences between a current version of the software and the version of the software of the nearby vehicle, wherein the software update is formed from a plurality of data chunks; and
transmit the software update to the nearby vehicle by individually transmitting the plurality of data chunks to the nearby vehicle.

2. The system according to claim 1, wherein the at least one processor is configured to execute the instructions to generate the software update by:
determining the one or more differences between the current version of the software and the version of the software of the nearby vehicle;
generating the hashmap based on the one or more differences;
obtaining data associated with the one or more differences based on the hashmap; and
dividing the data into the plurality of data chunks to form the software update.

3. The system according to claim 1, wherein the at least one processor is configured to execute the instructions to transmit the software update by:
determining priorities of the plurality of data chunks; and
individually transmitting the plurality of data chunks to the nearby vehicle based on the priorities.

4. The system according to claim 3, wherein the priorities of the plurality of data chunks are determined based on one or more of an update applicability of the respective one of the plurality of data chunks, a size of the respective one of the plurality of data chunks, a safety impact of the respective one of the plurality of data chunks, and a reboot of ECU applicability of the respective one of the plurality of data chunks.

5. The system according to claim 2, wherein the one or more differences between the current version of the software and the version of the software of the nearby vehicle are determined based on a differential comparison algorithm.

6. The system according to claim 5, wherein the differential comparison algorithm comprises Levenshtein distance algorithm.

7. The system according to claim 1, wherein the plurality of data chunks are individually transmitted via torrent.

8. The system according to claim 1, wherein the software of the nearby vehicle is divided into at least an application partition and a base partition, and wherein the nearby vehicle is configured to update the software of the nearby vehicle by applying the plurality of data chunks of the software update to a corresponding portions of the application partition and a corresponding portions of the base partition.

9. A method comprising:
receiving software information from a nearby vehicle, wherein the software information comprises a version of a software of the nearby vehicle;
generating a software update based on a hashmap indicating one or more differences between a current version of the software and the version of the software of the nearby vehicle, wherein the software update is formed from a plurality of data chunks; and
transmitting the software update to the nearby vehicle by individually transmitting the plurality of data chunks to the nearby vehicle.

10. The method according to claim 9, wherein the generating the software update comprises:
determining the one or more differences between the current version of the software and the version of the software of the nearby vehicle;
generating the hashmap based on the one or more differences;
obtaining data associated with the one or more differences based on the hashmap; and
dividing the data into the plurality of data chunks to form the software update.

11. The method according to claim 9, wherein the transmitting the software update comprises:
determining priorities of the plurality of data chunks; and
individually transmitting the plurality of data chunks to the nearby vehicle based on the priorities.

12. The method according to claim 11, wherein the priorities of the plurality of data chunks are determined based on one or more of an update applicability of the respective one of the plurality of data chunks, a size of the respective one of the plurality of data chunks, a safety impact of the respective one of the plurality of data chunks, and a reboot of ECU applicability of the respective one of the plurality of data chunks.

13. The method according to claim 10, wherein the one or more differences between the current version of the software and the version of the software of the nearby vehicle are determined based on a differential comparison algorithm.

14. The method according to claim 13, wherein the differential comparison algorithm comprises Levenshtein distance algorithm.

15. The method according to claim 9, wherein the plurality of data chunks are individually transmitted via torrent.

16. The method according to claim 9, wherein the software of the nearby vehicle is divided into at least an application partition and a base partition, and wherein the nearby vehicle is configured to update the software of the nearby vehicle by applying the plurality of data chunks of the software update to a corresponding portions of the application partition and a corresponding portions of the base partition.

17. A non-transitory computer-readable recording medium having recorded thereon instructions executable by at least one processor to cause the at least one processor to perform a method comprising:
receiving software information from a nearby vehicle, wherein the software information comprises a version of a software of the nearby vehicle;
generating a software update based on a hashmap indicating one or more differences between a current version of the software and the version of the software of the nearby vehicle, wherein the software update is formed from a plurality of data chunks; and
transmitting the software update to the nearby vehicle by individually transmitting the plurality of data chunks to the nearby vehicle.

18. The non-transitory computer-readable recording medium according to claim 17, wherein the generating the software update comprises:
determining the one or more differences between the current version of the software and the version of the software of the nearby vehicle;
generating the hashmap based on the one or more differences;
obtaining data associated with the one or more differences based on the hashmap; and
dividing the data into the plurality of data chunks to form the software update.

19. The non-transitory computer-readable recording medium according to claim 17, wherein the transmitting the software update comprises:
determining priorities of the plurality of data chunks; and
individually transmitting the plurality of data chunks to the nearby vehicle based on the priorities.

20. The non-transitory computer-readable recording medium according to claim 18, wherein the one or more differences between the current version of the software and the version of the software of the nearby vehicle are determined based on a differential comparison algorithm.
